(19) United States
(12) Patent Application Publication
(10) Pub. No.: US 2022/0234415 A1
(43) Pub. Date: Jul. 28, 2022

(54) AIR-CONDITIONING UNIT

(71) Applicant: DENSO CORPORATION, Kariya-city (JP)

(72) Inventor: Satoshi KUSANAGI, Kariya-city (JP)

(21) Appl. No.: 17/722,609

(22) Filed: Apr. 18, 2022

Related U.S. Application Data
(63) Continuation of application No. PCT/JP2020/036353, filed on Sep. 25, 2020.

(30) Foreign Application Priority Data
Oct. 30, 2019 (JP) 2019-197867

(51) Int. Cl. B60H 1/00

(52) U.S. Cl. CPC B60H 1/00057; B60H 1/00028; B60H 2001/00121; B60H 2001/00107; B60H 2001/00135

(57) ABSTRACT

An air-conditioning unit is configured to operate in an internal/external air two-layer mode. The air-conditioning unit includes an air-conditioning case defining a passage, a first heat exchanger, a second heat exchanger, an upstream partition and an intermediate partition. The upstream partition and the intermediate partition collectively partition the passage into a first passage through which internal air introduced from an internal air introducing port flows during the two-layer mode and a second passage through which external air introduced from an external air introducing port flows during the two-layer mode. The upstream partition is located upstream of the first heat exchanger and the intermediate partition is located between the first heat exchanger and the second heat exchanger. The intermediate partition is integrally formed with at least one of the first heat exchanger or the second heat exchanger.

### CROSS REFERENCE TO RELATED APPLICATION

The present application is a continuation application of International Patent Application No. PCT/JP2020/036353 filed on Sep. 25, 2020, which designated the U.S. and claims the benefit of priority from Japanese Patent Application No. 2019-197867 filed on Oct. 30, 2019. The entire disclosures of all of the above applications are incorporated herein by reference.

### TECHNICAL FIELD

The present disclosure relates to a vehicular air-conditioning unit.

### BACKGROUND

An air conditioning unit for a vehicle compartment that can operate in an internal/external air two-layer mode has been known. During the internal/external air two-layer mode, an air inside of the vehicle compartment (hereinafter referred to as an internal air) and an air outside of the vehicle compartment (hereinafter referred to as an external air) are separately introduced into the vehicle compartment.

### SUMMARY

An air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition, and an intermediate partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the intermediate partition collectively partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The intermediate partition is located between the first heat exchanger and the second heat exchanger to partition an intermediate part of the passage between the first heat exchanger and the second heat exchanger into the first passage and the second passage.

According to another aspect of the present disclosure, an air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition, and a downstream partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the downstream partition partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The downstream partition is located on a downstream surface of the second heat exchanger that faces away from the first heat exchanger to partition a downstream part of the passage downstream of the second heat exchanger in the airflow direction into the first passage and the second passage.

### BRIEF DESCRIPTION OF DRAWING

FIG. 1 is a cross-sectional view of an air-conditioning unit according to a first embodiment.

FIG. 2 is a schematic view illustrating a first heat exchanger, a second heat exchanger, and their vicinity in a passage of the air-conditioning unit of the first embodiment.

FIG. 3 is a perspective view of a PTC heater as the second heat exchanger viewed from an upstream side of the PTC heater in an airflow direction.

FIG. 4 is a perspective view of the PTC heater as the second heat exchanger viewed from a downstream side of the PTC heater in the airflow direction.

FIG. 5 is an explanatory diagram illustrating a step of arranging the second heat exchanger into the air-conditioning case through an opening.

FIG. 6 is an explanatory diagram illustrating the step of arranging the second heat exchanger into the air-conditioning case through the opening.

FIG. 7 is a cross-sectional view of an air-conditioning unit according to a second embodiment.

FIG. 8 is a schematic view illustrating the first heat exchanger, the second heat exchanger, and their vicinity in the passage of the air-conditioning unit of the second embodiment.

FIG. 9 is a schematic view illustrating the first heat exchanger, the second heat exchanger, and their vicinity in the passage of an air-conditioning unit of a third embodiment.

FIG. 10 is a cross-sectional view of an example of a downstream partition in a fourth embodiment.

FIG. 11 is a cross-sectional view of an example of a downstream partition in a fifth embodiment.

FIG. 12 is a cross-sectional view of an example of a downstream partition in a sixth embodiment.

FIG. 13 is a front view of a dummy heat exchanger as a second heat exchanger included in an air-conditioning unit of a seventh embodiment.

FIG. 14 is a cross-sectional view taken along a line XIV-XIV of FIG. 13.

FIG. 15 is a schematic view illustrating a first heat exchanger, a second heat exchanger, and their vicinity in a passage of an air conditioning unit of a comparative example.

### DESCRIPTION OF EMBODIMENTS

To begin with, examples of relevant techniques will be described.

Conventionally, an air conditioning unit for a vehicle compartment that can operate in an internal/external air two-layer mode has been known. During the internal/external air two-layer mode, an air inside of the vehicle compartment (hereinafter referred to as an internal air) and an air outside of the vehicle compartment (hereinafter referred to as an external air) are separately introduced into the vehicle compartment.

The air-conditioning unit includes a first passage through which the external air flows during the two-layer mode, a second passage through which the internal air flows during the two-layer mode, and a plurality of partitions that separate the first passage from the second passage. The plurality of partitions are provided on the upstream side of an evaporator, between the evaporator and a heater core, between the heater core and an auxiliary heater, and on the downstream side of the auxiliary heater, respectively. All of the partitions and an air-conditioning case are integrally formed with each other by using resin.

By the way, it is desired to downsize the air-conditioning unit installed in the vehicle due to spatial restrictions of the vehicle. In order to satisfy this desire, it is conceivable to arrange the heater core and the auxiliary heater close to each other. However, in that case, the width of the partition (hereinafter referred to as an intermediate partition) between the heater core and the auxiliary heater is decreased. As described above, all of the partitions and the air-conditioning case are integrally formed with each other, and the intermediate partition is also integrally formed with the air-conditioning case. The decreased width of the intermediate partition may cause issues such as molding failure of the intermediate partition, insufficient rigidity of the intermediate partition, and poor fitting between left and right split case parts constituting the air conditioning case. Therefore, it is difficult to downsize the air-conditioning unit.

It is an objective of the present disclosure to provide an air-conditioning unit that can be downsized.

According to one aspect of the present disclosure, an air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition, and an intermediate partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the intermediate partition collectively partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The intermediate partition is located between the first heat exchanger and the second heat exchanger to partition an intermediate part of the passage between the first heat exchanger and the second heat exchanger into the first passage and the second passage.

According to this, since the area where at least one of the first heat exchanger and the second heat exchanger is connected to the intermediate partition increases. Thus, the rigidity of the intermediate partition can be increased and formability of the intermediate partition can be improved even when the width of the intermediate partition is decreased. Further, since the air-conditioning case and the intermediate partition are separately formed from each other, poor fitting between left and right split cases forming the air-conditioning case does not occur even when the width of the intermediate partition is decreased. Therefore, in this air-conditioning unit, the first heat exchanger and the second heat exchanger can be arranged close to each other, and the air-conditioning unit can be downsized.

According to another aspect of the present disclosure, an air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition, and a downstream partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the downstream partition partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The downstream partition is located on a downstream surface of the second heat exchanger that faces away from the first heat exchanger to partition a downstream part of the passage downstream of the second heat exchanger in the airflow direction into the first passage and the second passage.

According to this, since the area where the second heat exchanger and the downstream partition are connected is increased, it is possible to increase the rigidity of the downstream partition and the formability of the downstream partition is improved even when the width of the downstream partition is decreased. In addition, since the air-conditioning case and the downstream partition are separately formed from each other, a poor fitting between the left and right split cases forming the air-conditioner case does not occur even when the width of the intermediate partition is decreased. Therefore, in this air-conditioning unit, the downstream partition can be thinner, and the air-conditioning unit can be downsized.

Embodiments of the present disclosure will now be described with reference to the drawings. In the following embodiments, the same or equivalent parts are denoted by the same reference numerals, and their descriptions will be omitted. In the following description, the terms “upper”, “lower”, “left”, and “right” are used for descriptive purpose, and do not limit the direction in which the air-conditioning unit is installed.

### First Embodiment

A first embodiment will be described with reference to the drawings. An air-conditioning unit 1 of the present embodiment is arranged inside an instrument panel of a vehicle (not shown). The air-conditioning unit 1 draws one or both of an air inside of a vehicle compartment (hereinafter referred to as an internal air) and an air outside of the vehicle compartment (hereinafter referred to as an external air), conditions the temperature and the humidity of the drawn air, and blows the conditioned air for air-conditioning in the vehicle compartment. Further, the air-conditioning unit 1 of the present embodiment can operate in an internal/external air two-layer mode during which the internal air and the external air are separately supplied into the vehicle compartment.

First, the overall configuration of the air-conditioning unit 1 of the present embodiment will be described.

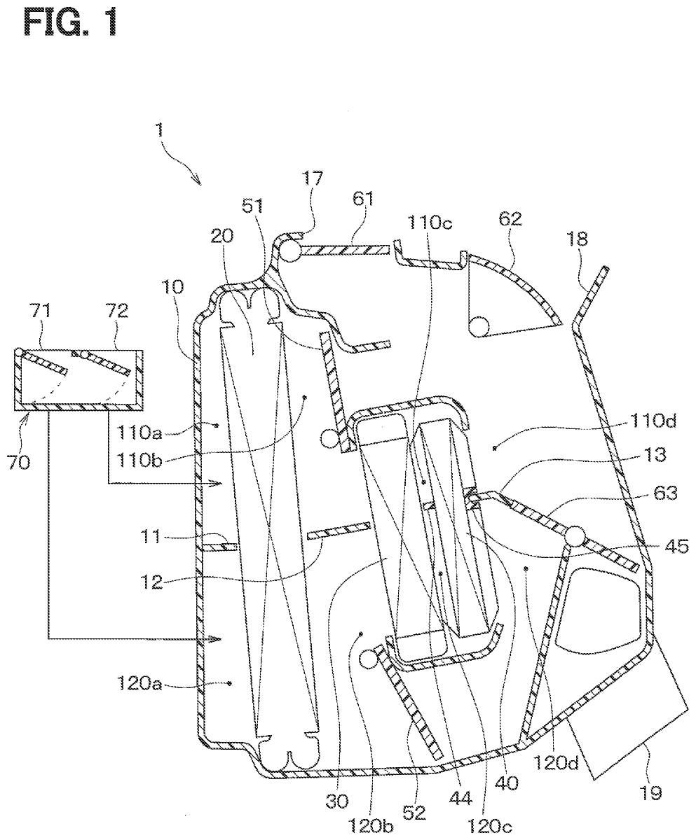

As shown in FIG. 1, the air-conditioning unit 1 includes an air-conditioning case 10, an evaporator 20, a heater core 30 as an example of a first heat exchanger, a PTC heater 40 as an example of a second heat exchanger, and air mix doors 51 and 52, mode doors 61, 62, 63 and the like. The PTC heater is an abbreviation for Positive Temperature Coefficient heater.

The air-conditioning case 10 of the air-conditioning unit 1 is made of a resin (for example, polypropylene) having a certain degree of elasticity and excellent strength. The air-conditioning case 10 defines a passage through which air flows inside an outer wall of the air-conditioning case. Further, the air-conditioning case 10 has multiple partitions for supplying the internal air and the external air separately into the vehicle compartment during the two-layer mode.

In the following description, among the partitions arranged in the air-conditioning case 10, one disposed upstream of the evaporator 20 is referred to as a first upstream partition 11 and one disposed between the evaporator 20 and the heater core 30 is referred to as a second upstream partition 12. Further, one disposed downstream of the PTC heater 40 is referred to as a downstream case partition 13.

The first upstream partition 11 divides an upstream part of the passage upstream of the evaporator 20 into a first passage 110a and a second passage 120a. The second upstream partition 12 divides an upstream part of the passage between the evaporator 20 and the heater core 30 into a first passage 110b and a second passage 120b. The downstream case partition 13 divides a part of the passage downstream of the PTC heater 40 into a first passage 110d and a second passage 120d. The first passages 110a, 110b, 110c and 110d are regions above the partitions in FIG. 1. The first passages 110a, 110b, 110c and 110d are passages through which the external air flows during the two-layer mode. The second passages 120a, 120b, 120c and 120a are regions below the partitions in FIG. 1. The second passages 120a, 120b, 120c and 120a are passages through which the internal air flows during the two-layer mode.

In this specification and drawings, letters a to d are added to the end of reference numeral 110 according to the position of the first passage 110. In addition, letters a to d are added to the end of the reference numeral 120 according to the position of the second passage 120.

The first passage 110a and the second passage 120a that are located upstream of the evaporator 20 are passages into which air is introduced from the blower unit 70. The blower unit 70 is configured to supply air introduced from at least one of an internal air introducing port 71 and an external air introducing port 72 into the first passage 110a and the second passage 120a that are located upstream of the evaporator 20 by an operation of a blower (not shown). Further, the blower unit 70 is configured to supply the external air introduced from the external air introducing port 72 into the first passage 110a and the internal air introduced from the internal air introducing port 71 into the second passage 120a during the two-layer mode. Therefore, during the two-layer mode, the external air flows through the first passages 110a to 110d and the internal air flows through the second passages 120a to 120d.

Further, the air-conditioning case 10 defines, on the downstream side of the heat exchangers, outlet openings 17, 18, and 19 for blowing air flowing through the passages into the vehicle compartment. Therefore, at least one of the internal air introduced from the internal air introducing port 71 of the blower unit 70 and the external air introduced from the external air introducing port 72 of the blower unit 70 flows through the passages in the air-conditioning case 10 and is supplied into the vehicle compartment.

The outlet openings 17, 18 and 19 are formed of a defroster outlet opening 17, a face outlet opening 18, and a foot outlet opening 19. The defroster outlet opening 17 is for blowing the conditioned air toward a windshield of the vehicle. The face outlet opening 18 is for blowing the conditioned air toward an upper body of an occupant seated on a front seat. The foot outlet opening 19 is for blowing the conditioned air toward legs of the occupant seated on the front seat. A duct (not shown) is attached to each of the outlet openings 17, 18, and 19. The duct is connected to each outlet defined at a predetermined position in the vehicle compartment.

The evaporator 20 is a refrigerant heat exchanger for cooling the air flowing through the passages of the air-conditioning case 10. The evaporator 20 constitutes a known refrigeration cycle together with a compressor, a condenser, an expansion valve, etc. (not shown). The evaporator 20 is arranged downstream of the expansion valve and upstream of the compressor in the refrigeration cycle. The evaporator 20 includes tubes (not shown) and refrigerant in a gas-liquid two-layer state that is generated by being decompressed by the expansion valve flows through the tubes. The evaporator 20 is configured to cool air through heat exchange between the refrigerant flowing through the tubes and the air flowing outside the tubes.

The first heat exchanger adjusts the temperature of the air flowing through the passages of the air-conditioning case 10. Specifically, the heater core 30 as the first heat exchanger is a hot water heat exchanger for heating air flowing through the passages of the air-conditioning case 10. The heater core 30 is disposed in the passage of the air-conditioning case 10 at a position downstream of the evaporator 20 in the airflow direction. The heater core 30 includes tubes (not shown) through which heat medium such as an engine cooling water flows. The heater core 30 is configured to heat the air through heat exchange between the heat medium flowing through the tubes and the air flowing outside the tubes.

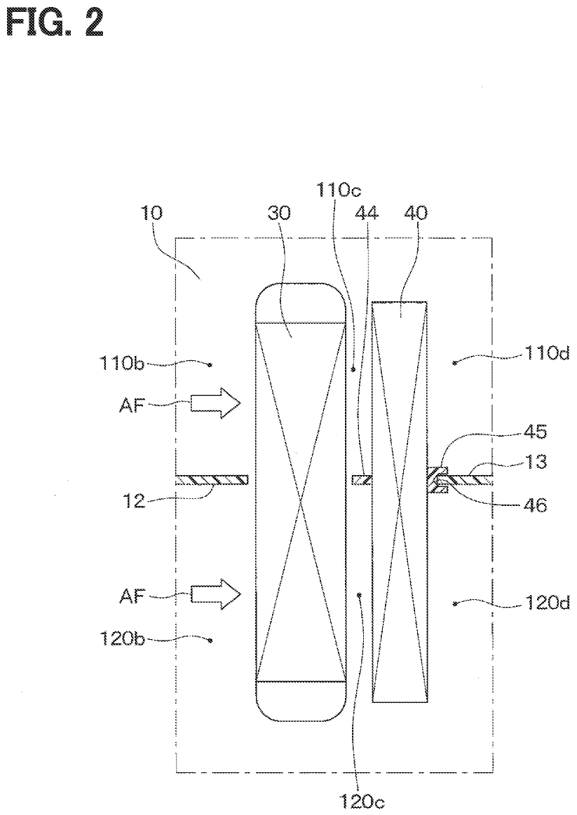

As shown in FIGS. 1 and 2, the second heat exchanger is arranged downstream of the above-mentioned first heat exchanger in the airflow direction. The arrows AF in FIG. 2 indicate the airflow direction. The PTC heater 40 as the second heat exchanger and the heater core 30 as the first heat exchanger are arranged substantially in parallel and close to each other.

The PTC heater 40 is an electric heat exchanger for heating the air flowing through the passages of the air-conditioning case 10. The PTC heater 40 energizes an electric resistor to generate heat. The PTC heater 40 is configured to heat the air through heat exchange between heat radiation fins including the electric resistor and the air flowing between the heat radiation fins.

The PTC heater 40 includes an upstream surface facing the heater core 30 and the upstream surface includes an intermediate partition 44. The intermediate partition 44 divides an intermediate part of the passage between the heater core 30 and the PTC heater 40 into the first passage 110c and the second passage 120c. The PTC heater 40 includes a downstream surface facing away from the heater core 30 and the downstream surface includes a downstream partition 45. The downstream partition 45 partitions a downstream part of the passage downstream of the PTC heater 40 in the airflow direction into the first passage 110d and the second passage 120d.

Further, the downstream partition 45 disposed on the PTC heater 40 is engageable with a downstream case partition 13 disposed on the air-conditioning case 10. Specifically, the downstream partition 45 defines a guide groove 46 on a portion opposite to the PTC heater 40. The guide groove 46 is recessed toward the PTC heater 40. A part of the downstream case partition 13 is fit into the guide groove 46. The specific configurations of the PTC heater 40, the intermediate partition 44 and the downstream partition 45 will be described later.

As shown in FIG. 1, the air mix doors 51, 52 and the mode doors 61, 62, 63 are provided in the passages of the air-conditioning case 10.

The air mix doors 51 and 52 are formed of two sliding doors provided between the evaporator 20 and the heater core 30. In the state shown in FIG. 1, the air mix doors 51 and 52 are arranged so that all of the air that has passed through the evaporator 20 flows through the heater core 30. By changing the positions of the air mix doors 51 and 52, it is possible to allow a part or all of the air that has passed through the evaporator 20 to bypass the heater core 30. The positions of the air mix doors 51 and 52 are switched according to the selected air-conditioning mode.

The mode doors 61, 62, 63 are formed of a defroster door 61, a face door 62 and a foot door 63. The defroster door 61 adjusts the flow rate of air blown out through the defroster outlet opening 17. The face door 62 adjusts the flow rate of air blown out through the face outlet opening 18. The foot door 63 adjusts the flow rate of air blown out through the foot outlet opening 19. The positions of the mode doors 61, 62, 63 are also switched according to the selected air-conditioning mode.

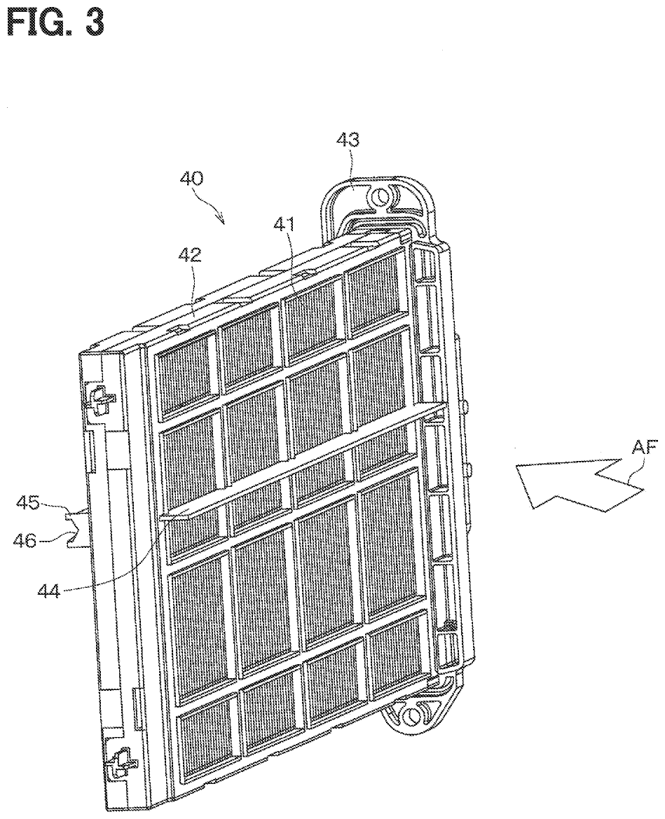

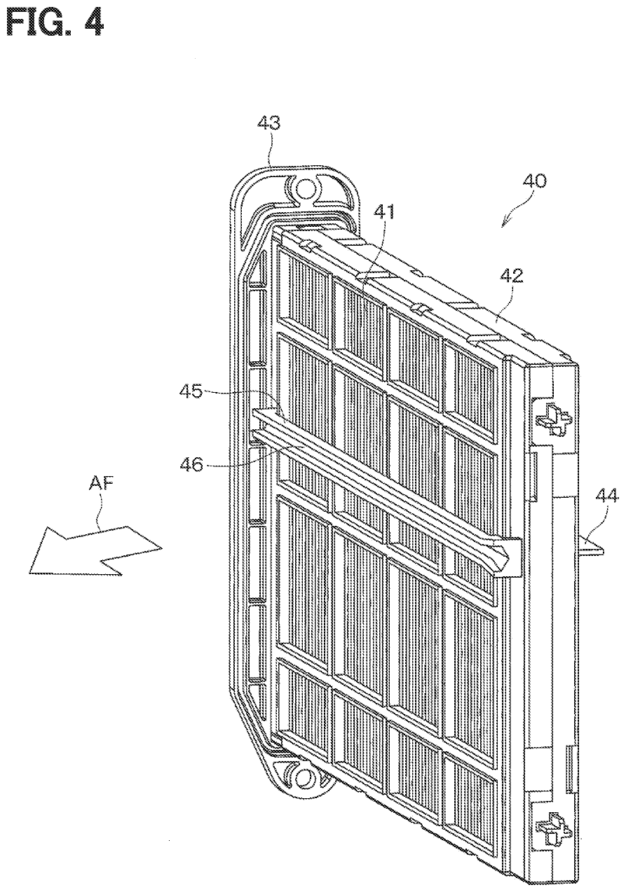

Next, a specific configuration of the PTC heater 40, the intermediate partition 44 and the downstream partition 45 will be described with reference to FIGS. 3 and 4. The arrow AF in FIGS. 3 and 4 indicates the airflow direction when the PTC heater 40 is installed in the air-conditioning case 10.

As shown in FIGS. 3 and 4, the PTC heater 40 has a heat radiation fins 41, a frame 42, a flange 43 and the like. Further, the intermediate partition 44 and the downstream partition 45 are integrally formed with the frame 42 and the flange 43 of the PTC heater 40.

Specifically, the heat radiation fins 41 of the PTC heater 40 include electric resistors that generate heat when energized, and are arranged in parallel to each other at predetermined intervals. The air is heated while flowing between the heat radiation fins 41. The frame 42 forms an outer frame of the heat radiation fins 41. The frame 42 is made of a resin (for example, PA66/GF) having excellent heat resistance, rigidity and dimensional stability. The flange 43 is arranged at one end of the frame 42. The flange 43 is also made of a resin having the same characteristics as the frame 42. At a portion of the flange 43 opposite to the radiation fins 41, a connector (not shown) for energizing the electric resistors is disposed.

As shown in FIG. 3, the intermediate partition 44 is provided on the upstream surface of the PTC heater 40 (i.e., the surface facing the heater core 30). The intermediate partition 44 is also made of a resin having the same characteristics as the frame 42 and the flange 43. The intermediate partition 44, the frame 42 and the flange 43 are integrally formed by using resin. That is, the intermediate partition 44 is connected to the frame 42 and the flange 43. Therefore, the intermediate partition 44 has a highly rigid structure.

On the other hand, as shown in FIG. 4, the downstream partition 45 is disposed on the downstream surface of the PTC heater 40 (i.e., the surface facing away from the heater core 30). The downstream partition 45 is also made of a resin having the same characteristics as the frame 42 and the flange 43. The downstream partition 45, the frame 42 and the flange 43 are integrally formed by using resin. That is, the downstream partition 45 is connected to the frame 42 and the flange 43. Therefore, the downstream partition 45 also has a highly rigid structure.

Next, a method for arranging the PTC heater 40 into the air conditioning case 10 will be described.

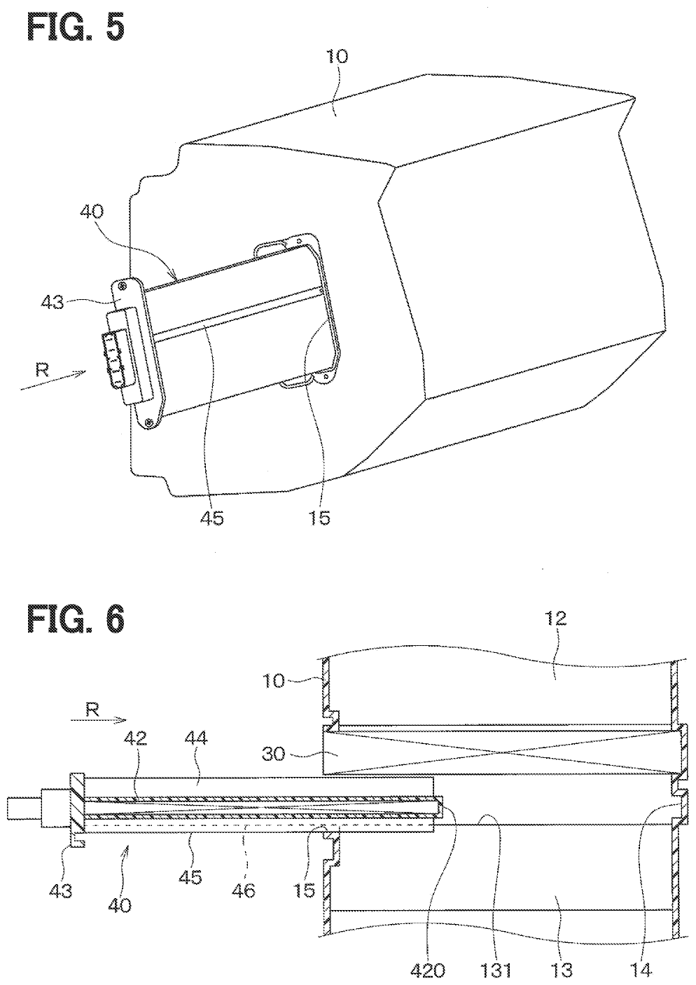

FIGS. 5 and 6 illustrate how to arrange the PTC into the air-conditioning case 10. The outer wall of the air-conditioning case 10 defines an opening 15 through which the PTC heater 40 is inserted and removed. In FIGS. 5 and 6, the direction in which the PTC heater 40 is inserted into the passage through the opening 15 of the air-conditioning case 10 is shown by the arrow R. The opening 15 of the air-conditioning case 10 has an area such that the PTC heater 40 can be inserted and removed together with the heater core 30.

As shown in FIGS. 2 and 4, the downstream partition 45 arranged on the PTC heater 40 has the guide groove 46 that is engageable with the downstream case partition 13 located on the air-conditioning case 10. Therefore, the PTC heater 40 can be inserted into the passage through the opening 15 of the air-conditioning case 10 as shown in FIG. 6. That is, as shown in FIG. 6, the PTC heater 40 is inserted and slid into the passage while the guide groove 46 on the downstream partition 45 is slidably engaged with an end portion of the downstream case partition 13 that faces the PTC heater 40. As a result, the PTC heater 40 is inserted into the passage without being offset in the vertical direction and in the horizontal direction. Therefore, the end portion 420 of the PTC heater 40 opposite to the flange 43 can be easily and surely fit into a fitting portion 14 of the air-conditioning case 10 that is located opposite to the opening 15.

Here, in order to compare with the air-conditioning unit 1 of the first embodiment described above, an air-conditioning unit of a comparative example will be described.

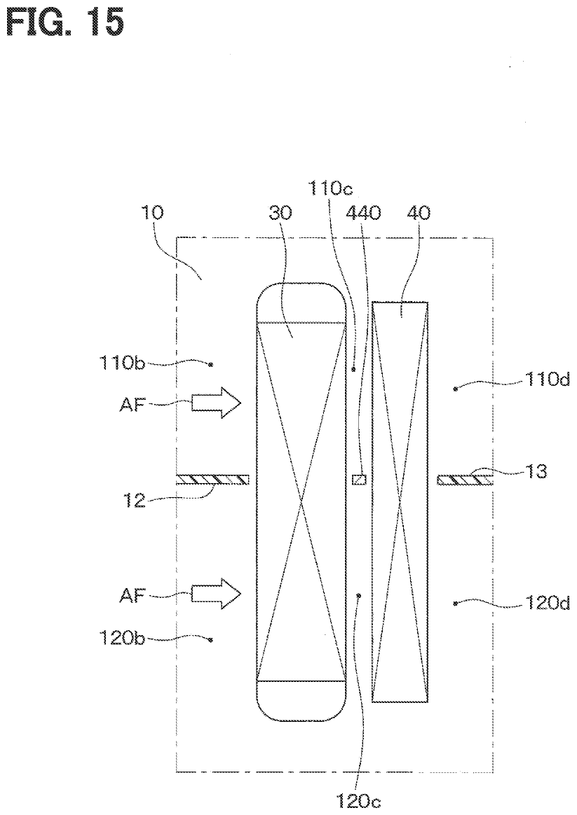

FIG. 15 is an enlarged view of the heater core 30, the PTC heater 40 and the vicinity thereof provided in the air-conditioning unit of the comparative example, and shows portions corresponding to FIG. 2 of the first embodiment described above.

As shown in FIG. 15, in the comparative example, the intermediate partition 440 is provided on the air-conditioning case 10. That is, both ends of the intermediate partition 440 (i.e., a front portion and a back portion of the intermediate partition 440 relative to a paper plane of FIG. 15) are connected to the inner wall of the air-conditioning case 10. When the heater core 30 and the PTC heater 40 are arranged close to each other in this case, the width of the intermediate partition 440 is decreased. The decreased width of the intermediate partition 440 may cause a deterioration of separation of the internal air and the external air due to molding error of the intermediate partition 440, break of the intermediate partition 440 due to a lack of rigidity, or a poor fitting between right and left split cases forming the air-conditioning case 10.

Further, the air-conditioning unit of the comparative example does not include the downstream partition on a downstream surface of the PTC heater 40 opposite to the heater core 30. Therefore, when the PTC heater 40 is inserted into the passage through the opening 15 of the air-conditioning case 10, the PTC heater 40 is easily offset in the vertical direction and the horizontal direction. Therefore, when the PTC heater 40 is arranged in the comparative example, it is difficult to fit the end portion 420 of the PTC heater 40 that is located opposite to the flange 43 into the fitting portion 14 that is disposed on a part of the air-conditioning case 10 opposite to the opening 15.

The air-conditioning unit 1 of the first embodiment has the following advantages compared to the air-conditioning unit of the comparative example described above.

(1) In the first embodiment, the intermediate partition 44 is provided on the upstream surface of the PTC heater 40 facing the heater core 30. As a result, a contact area between the PTC heater 40 and the intermediate partition 44 is increased, so that the rigidity of the intermediate partition 44 is increased and formability of the intermediate partition 44 is improved even when the width of the intermediate partition 44 is decreased. Further, the air-conditioning case 10 and the intermediate partition 44 are separately formed from each other, so that a poor fitting between right and left split cases forming the air-conditioning case 10 does not occur even when the width of the intermediate partition 44 is decreased. Therefore, in the air-conditioning unit 1, the heater core 30 and the PTC heater 40 can be arranged close to each other, and the air-conditioning unit 1 can be downsized.

(2) In the first embodiment, the downstream partition 45 is disposed on the downstream surface of the PTC heater 40 that faces away from the heater core 30. As a result, a contact area between the PTC heater 40 and the downstream partition 45 is increased, so that the rigidity of the downstream partition 45 is increased and formability of the downstream partition 45 is improved even when the width of the downstream partition 45 is decreased. Further, the air-conditioning case 10 and the downstream partition 45 are separately formed from each other, so that a poor fitting between right and left split cases forming the air-conditioning case 10 does not occur even when the width of the downstream partition 45 is decreased. Therefore, in this air-conditioning unit 1, the downstream partition 45 can be made thinner, and the air-conditioning unit 1 can be downsized.

(3) In the first embodiment, the PTC heater 40 can be inserted into and removed from the air-conditioning case 10 through the opening 15 while the downstream partition 45 disposed on the downstream surface of the PTC heater 40 is slidably engaged with the downstream case partition 13 disposed on the air-conditioning case 10.

According to this, it is possible to improve assembly efficiency of the PTC heater 40 into the air-conditioning case 10. Therefore, the cycle time during the manufacture can be shortened, and the manufacturing cost can be reduced.

(4) In the first embodiment, the frame 42, the intermediate partition 44 and the downstream partition 45 of the PTC heater 40 are integrally formed with each other. As a result, the rigidity of the intermediate partition 44 and the downstream partition 45 can be increased, and the manufacturing cost can be reduced.

### Second Embodiment

A second embodiment will be described. In the second embodiment, the configurations of the intermediate partition 44 and the downstream partition 45 are changed from those in the first embodiment. Other portions are similar to those of the first embodiment and different portions from the first embodiment are mainly described.

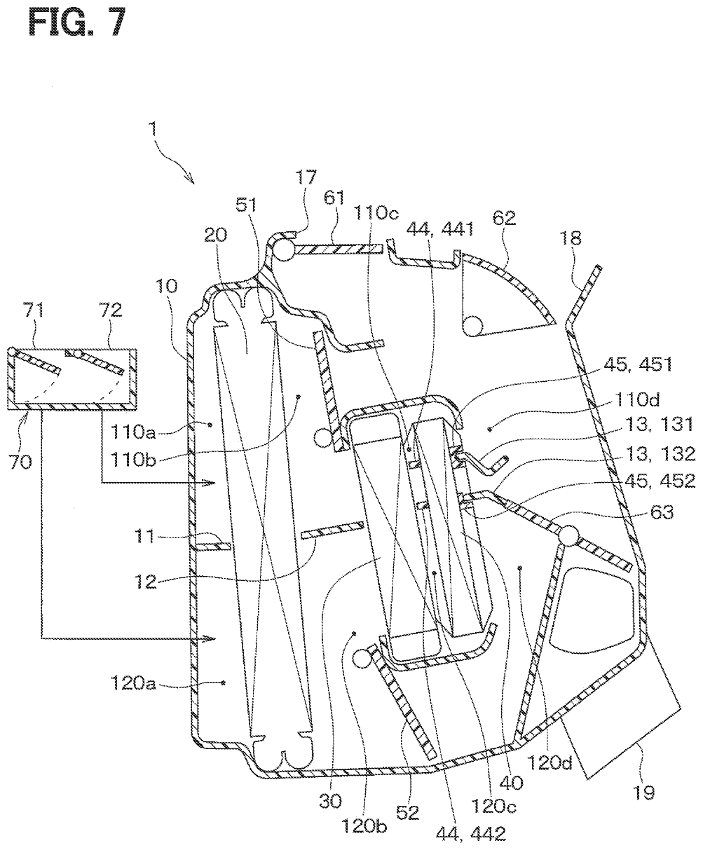

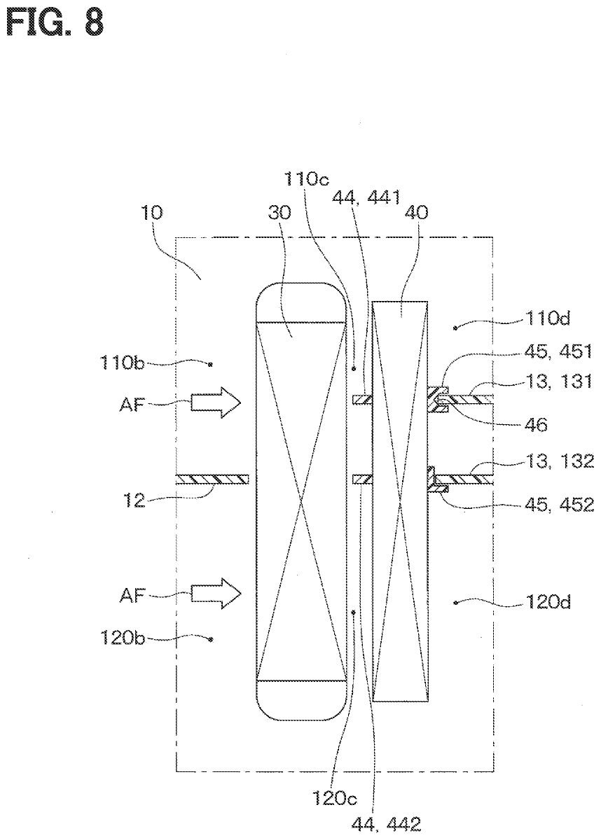

As shown in FIGS. 7 and 8, in the second embodiment, the intermediate partition 44 includes a plurality of intermediate partition elements that are spaced away from each other and the downstream partition 45 includes a plurality of downstream partition elements that are spaced away from each other. Specifically, the number of the intermediate partition elements is two and the number of the downstream partition elements is two. Of the multiple intermediate partition elements, upper one (i.e., one disposed closer to the defroster outlet opening 17) is referred to as a first intermediate partition element 441 and lower one disposed below the first intermediate partition element 441 is referred to as a second intermediate partition element 442.

Of the multiple downstream partition elements, upper one is referred to as a first downstream partition element 451 and lower one disposed below the first downstream partition element 451 is referred to as a second downstream partition element 452.

Further, in the second embodiment, the downstream case partition 13 has two downstream case partition elements. Of the two downstream case partition elements, upper one is referred to as a first downstream case partition element 131 and lower one disposed below the first downstream case partition element 131 is referred to as a second downstream case partition element 132. The first downstream partition element 451 and the second downstream partition element 452 are disposed at positions corresponding to an end of the foot door 63 when the foot door 63 is rotated. Therefore, the air-conditioning unit 1 of the second embodiment can finely adjust the flow rate of the air blown out each of the outlet openings 17, 18, 19 according to the selected air-conditioning mode.

The first intermediate partition element 441 and the first downstream partition element 451 are located at substantially the same height on the PTC heater 40. Further, the second intermediate partition element 442 and the second downstream partition element 452 are located at substantially the same height on the PTC heater 40.

As shown in FIG. 8, the first downstream partition element 451 includes a guide groove 46 on an end surface opposite to the PTC heater 40. The guide groove 46 defined on the first downstream partition element 451 is configured to slidably engage with the first downstream case partition element 131. On the other hand, the second downstream partition element 452 does not define a guide groove. The second downstream partition element 452 is arranged to be in contact with or adjacent to the second downstream case partition element 132.

The PTC heater 40 can be inserted and slid into the passage through the opening 15 of the air-conditioning case 10 while the guide groove 46 of the first downstream partition element 451 is slidably engaged with the first downstream case partition element 131. At that time, the second downstream partition element 452 and the second downstream case partition element 132 are slidably in contact with each other. As a result, the PTC heater 40 can be easily inserted into the passage without being offset in the vertical direction and in the horizontal direction. In the second embodiment, only the first downstream partition element 451 defines the guide groove 46 and the second downstream partition element 452 does not define the guide groove 46. Thus, even when manufacturing tolerance of each member is increased, assembly efficiency does not deteriorate.

### Third Embodiment

A third embodiment will be described. In the third embodiment, the configuration of the downstream partition 45 is changed from that of the second embodiment, and the remaining configurations are the same as those of the second embodiment, and therefore, only portions different from the second embodiment will be described.

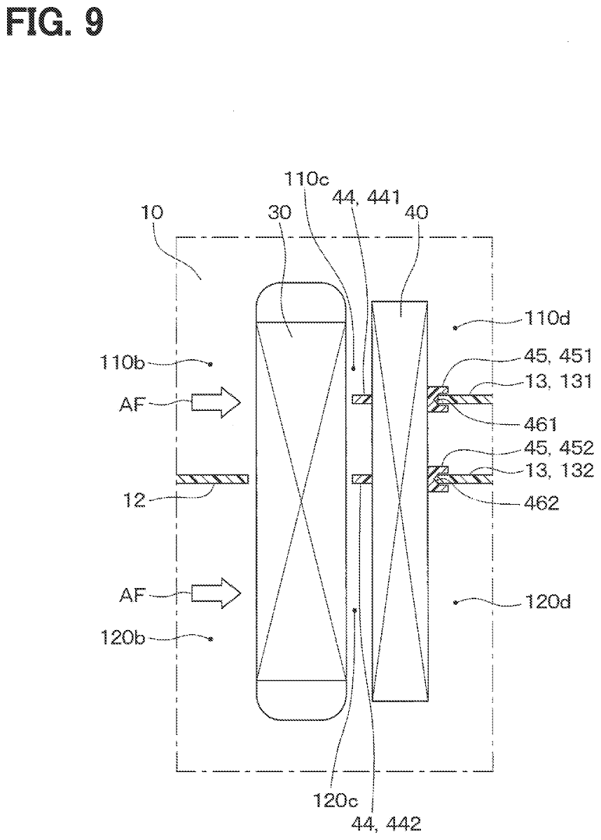

As shown in FIG. 9, in the third embodiment, each of the number of the intermediate partition elements and the number of the downstream partition elements is two. Then, in the third embodiment, the first downstream partition element 451 and the second downstream partition element 452 define the guide grooves 461 and 462, respectively. The guide groove 461 on the first downstream partition element 451 is configured to slidably engage with the first downstream case partition element 131. The guide groove 462 on the second downstream partition element 452 is configured to slidably engage with the second downstream case partition element 132.

When the PTC heater 40 is arranged in the air-conditioning case 10, the guide groove 461 of the first downstream partition element 451 is slidably engaged with the first downstream case partition element 131 and the guide groove 462 of the second downstream partition element 452 is slidably engaged with the second downstream case partition element 132. In that state, the PTC heater 40 is slid into the passage. As a result, the PTC heater 40 can be easily inserted into the passage without being offset in the vertical direction and in the horizontal direction.

### Fourth to Sixth Embodiments

Fourth to sixth embodiments will be described. In the fourth to sixth embodiments, the shape of the downstream partition 45 is changed from that in the first embodiment, and the remaining parts are similar to those in the first embodiment, so only the difference from the first embodiment will be described.

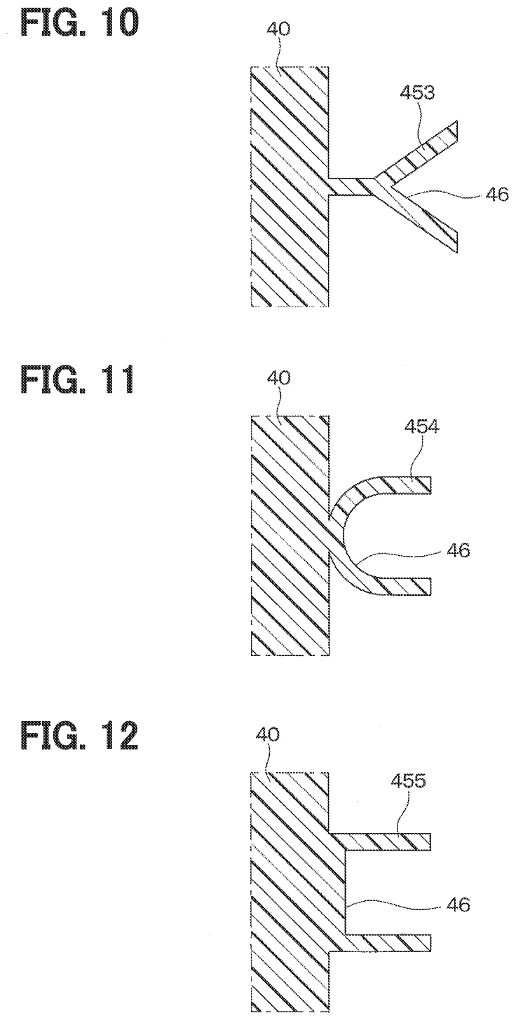

As shown in FIG. 10, in the fourth embodiment, the cross-section of a downstream partition 453 is Y-shaped. As shown in FIG. 11, in the fifth embodiment, the cross-section of a downstream partition 454 is U-shaped. As shown in FIG. 12, in the sixth embodiment, the cross-section of a downstream partition 455 has a shape in which two flat plates are arranged in parallel to each other. As described above, the shape of the downstream partition can be variously changed.

### Seventh Embodiment

A seventh embodiment will be described. In the seventh embodiment, the configuration of the second heat exchanger is changed from that in the first embodiment, and the remaining parts are similar to those in the first embodiment, so only the difference from the first embodiment will be described.

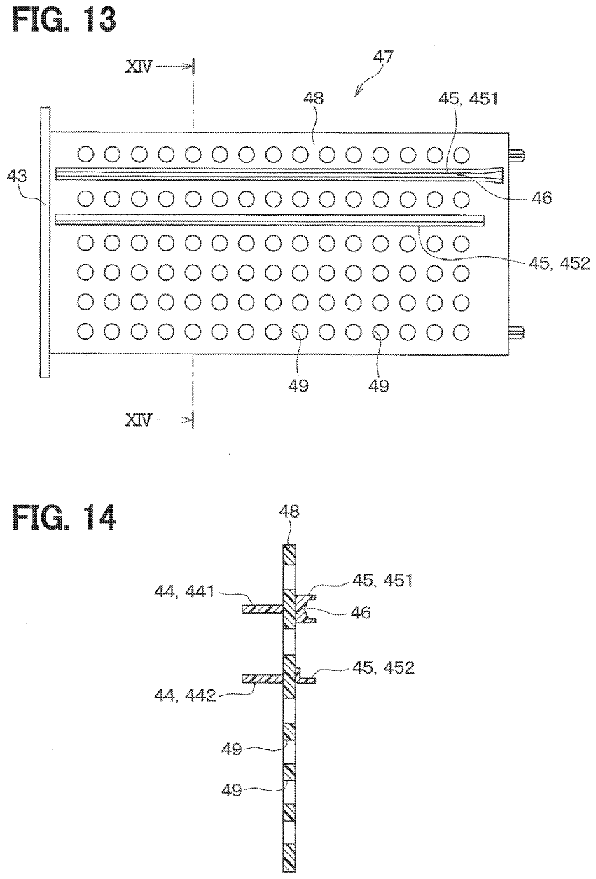

An air-conditioning unit 1 in the seventh embodiment includes a dummy heat exchanger 47 as shown in FIGS. 13 and 14 in place of the PTC heater 40 exemplified as the second heat exchanger in the first embodiment. The dummy heat exchanger 47 does not have a heat exchange function and is formed of a member having a predetermined air resistance.

Specifically, the dummy heat exchanger 47 has a plate member 48, a flange 43 and the like. The plate member 48 defines a plurality of holes 49 through which air can pass. The ventilation resistance of the plate member 48 is set to substantially the same as that of the PTC heater 40 exemplified in the first embodiment. The flange 43 is provided on one end of the plate member 48.

Further, the plate member 48 of the dummy heat exchanger 47 includes the intermediate partition 44 and the downstream partition 45. The intermediate partition 44 and the downstream partition 45 are integrally formed with the plate member 48 of the dummy heat exchanger 47.

Similar to the first embodiment, the air conditioning unit 1 of the seventh embodiment can also increase the rigidity of the intermediate partition 44 and the rigidity of the downstream partition 45 provided on the dummy heat exchanger 47 as the second heat exchanger. Thus, the formability of the intermediate partition 44 and the downstream partition 45 can be improved. Therefore, the heater core 30 and the dummy heat exchanger 47 can be arranged close to each other. Thus, the seventh embodiment can also achieve advantages similar to those of the first embodiment.

### OTHER EMBODIMENTS

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific numerical value. In each of the above embodiments, when the shapes, positional relationships, and the like of the components and the like are referred to, the shapes, positional relationships, and the like are not limited thereto unless otherwise specified or limited to specific shapes, positional relationships, and the like in principle.

(1) In each of the above embodiments, the heater core 30 is exemplified as the first heat exchanger, but the present disclosure is not limited to this. The first heat exchanger is, for example, a heat medium heat exchanger through which a heat medium other than engine cooling water flows, a refrigerant heat exchanger such as a condenser in a refrigerant cycle, or a refrigerant heat exchanger such as the evaporator 20 in the refrigerant cycle.

(2) In each of the above embodiments, the PTC heater 40 and the dummy heat exchanger 47 are exemplified as the second heat exchanger, but the present disclosure is not limited to this. The second heat exchanger may be an electric heat exchanger other than the PTC heater 40, a heat medium heat exchanger through which engine cooling water or another heat medium flows, or a refrigerant heat exchanger such as a condenser in a refrigerant cycle.

(3) In each of the above embodiments, the intermediate partition 44 between the first heat exchanger and the second heat exchanger is disposed on the second heat exchanger. However, the present disclosure is not limited to this. The intermediate partition 44 may be disposed on the first heat exchanger or on both of the first heat exchanger and the second heat exchanger.

(4) In the second embodiment, the number of the intermediate partition elements is two and the number of the downstream partition elements 45 is two. However, the present disclosure is not limited to this. The number of the intermediate partition elements and the number of the downstream partition elements are arbitrarily selected according to the performance required for the air-conditioning unit 1.

(5) In the above embodiments, the opening 15 of the air-conditioning case 10 has an opening area through which the heater core 30 can be inserted into and removed from the air-conditioning case 10 together with the PTC heater 40. However, the present disclosure is not limited to this. The opening 15 of the air conditioning case 10 may be formed of a first opening through which only the PTC heater 40 can be inserted and removed and a second opening through which the heater core 30 is inserted and removed.

(Overview)

According to a first aspect shown in a part or all of the above-described embodiment, the air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition and an intermediate partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the intermediate partition collectively partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The intermediate partition is located between the first heat exchanger and the second heat exchanger to partition an intermediate part of the passage between the first heat exchanger and the second heat exchanger into the first passage and the second passage.

According to a second aspect, the air-conditioning unit further includes a downstream partition. The downstream partition is located on a downstream surface of the second heat exchanger that faces away from the first heat exchanger to partition a downstream part of the passage downstream of the second heat exchanger in the airflow direction into the first passage and the second passage.

According to this, a contact area between the second heat exchanger and the downstream partition is increased. Therefore, even when the width of the downstream partition is decreased, the rigidity of the downstream partition can be increased, and the formability thereof is also improved. In addition, a poor fitting between the right and left split cases forming the air-conditioning case does not occur. Therefore, in this air-conditioning unit, the downstream partition can be thinner, and the air-conditioning unit can be downsized.

According to a third aspect, the air-conditioning case defines, on an outer wall thereof, an opening through which the second heat exchanger is inserted into and removed from the air-conditioning case. The air-conditioning case includes a downstream case partition that is disposed at a position downstream of the downstream partition in the airflow direction to partition a part of the passage downstream of the downstream partition into the first passage and the second passage. The second heat exchanger is configured to be inserted and removed from the air-conditioning case through the opening while the downstream partition is slidably engaged with the downstream case partition.

According to this, it is possible to improve the assembly efficiency of the second heat exchanger into the air-conditioning case. Therefore, the cycle time during the manufacture can be shortened, and the manufacturing cost can be reduced.

According to a fourth aspect, at least one of the intermediate partition and the downstream partition has a plurality of partition elements that are spaced away from each other.

According to this, it is possible to finely adjust the flow rate of air blown from each of the outlet openings of the air-conditioning case.

According to a fifth aspect, the second heat exchanger is an electric heat exchanger, a refrigerant heat exchanger, a heat medium heat exchanger or a dummy heat exchanger. The intermediate partition is integrally formed with a frame or a plate member of the second heat exchanger.

According to this, since the intermediate partition is integrally formed with the frame or the plate member of the second heat exchanger, the rigidity of the intermediate partition can be increased and the manufacturing cost can be reduced.

According to a sixth aspect, the second heat exchanger is an electric heat exchanger, a refrigerant heat exchanger, a heat medium heat exchanger or a dummy heat exchanger. The downstream partition is integrally formed with a frame or a plate member of the second heat exchanger.

According to this, since the downstream partition is integrally formed with the frame or the plate member of the second heat exchanger, the rigidity of the downstream partition can be increased and the manufacturing cost can be reduced.

According to a seventh aspect of the present disclosure, an air-conditioning unit is configured to operate in an internal/external air two-layer mode during which internal air and external air are separately supplied into a vehicle compartment. The air-conditioning unit includes an air-conditioning case, a first heat exchanger, a second heat exchanger, an upstream partition and a downstream partition. The air-conditioning case defines a passage through which an air introduced from at least one of an internal air introducing port or an external air introducing port flows toward the vehicle compartment in an airflow direction. The first heat exchanger is disposed in the passage and configured to adjust a temperature of the air flowing through the passage. The second heat exchanger is disposed in the passage at a position downstream of the first heat exchanger in the airflow direction. The upstream partition and the downstream partition partition the passage into a first passage through which the internal air introduced from the internal air introducing port flows during the internal/external air two-layer mode and a second passage through which the external air introduced from the external air introducing port flows during the internal/external air two-layer mode. The upstream partition is located upstream of the first heat exchanger in the airflow direction to partition an upstream part of the passage upstream of the first heat exchanger into the first passage and the second passage. The downstream partition is located on a downstream surface of the second heat exchanger that faces away from the first heat exchanger to partition a downstream part of the passage downstream of the second heat exchanger into the first passage and the second passage.

What is claimed is:

1. An air-conditioning unit configured to operate in an internal/external air two-layer mode during which internal air and external air are separately supplied into a vehicle compartment, the air-conditioning unit comprising:
an air-conditioning case defining a passage through which an air introduced from at least one of an internal air introducing port or an external air introducing port flows toward the vehicle compartment in an airflow direction;
a first heat exchanger disposed in the passage and configured to adjust a temperature of the air flowing through the passage;
a second heat exchanger disposed in the passage at a position downstream of the first heat exchanger in the airflow direction; and
an upstream partition and an intermediate partition collectively partitioning the passage into a first passage through which the internal air introduced from the internal air introducing port flows during the internal/external air two-layer mode and a second passage through which the external air introduced from the external air introducing port flows during the internal/external air two-layer mode, wherein
the upstream partition is located upstream of the first heat exchanger in the airflow direction to partition an upstream part of the passage upstream of the first heat exchanger into the first passage and the second passage,
the intermediate partition is located between the first heat exchanger and the second heat exchanger to partition an intermediate part of the passage between the first heat exchanger and the second heat exchanger into the first passage and the second passage, and
the intermediate partition is integrally formed with at least one of the first heat exchanger or the second heat exchanger.

2. The air-conditioning unit according to claim 1 further comprising
a downstream partition disposed on a downstream surface of the second heat exchanger that faces away from the first heat exchanger to partition a downstream part of the passage downstream of the second heat exchanger in the airflow direction into the first passage and the second passage.

3. The air-conditioning unit according to claim 2, wherein
the air-conditioning case defines, on an outer wall thereof, an opening through which the second heat exchanger is inserted into and removed from the air-conditioning case,
the air-conditioning case includes a downstream case partition that is disposed at a position downstream of the downstream partition in the airflow direction to partition a part of the passage downstream of the downstream partition into the first passage and the second passage, and
the second heat exchanger is configured to be inserted into and removed from the air-conditioning case through the opening while the downstream partition is engaged with the downstream case partition.

4. The air-conditioning unit according to claim 2, wherein
at least one of the intermediate partition or the downstream partition is formed of a plurality of partition elements that are spaced away from each other.

5. The air-conditioning unit according to claim 2, wherein
the second heat exchanger is an electric heat exchanger, a refrigerant heat exchanger, a heat medium heat exchanger or a dummy heat exchanger,
the second heat exchanger includes a frame and a plate member, and
the intermediate partition and the downstream partition are integrally formed with the frame or the plate member of the second heat exchanger.

6. The air-conditioning unit according to claim 2, wherein
the second heat exchanger is an electric heat exchanger, a refrigerant heat exchanger, a heat medium heat exchanger or a dummy heat exchanger,
the second heat exchanger includes a frame and a plate member, and
the downstream partition is integrally formed with the frame or the plate member of the second heat exchanger.

7. An air-conditioning unit configured to operate in an internal/external air two-layer mode during which internal air and external air are separately supplied into a vehicle compartment, the air-conditioning unit comprising:
an air-conditioning case defining a passage through which an air introduced from at least one of an internal air introducing port or an external air introducing port flows toward the vehicle compartment in an airflow direction;
a first heat exchanger disposed in the passage and configured to adjust a temperature of the air flowing through the passage;
a second heat exchanger disposed in the passage at a position downstream of the first heat exchanger in the airflow direction; and
an upstream partition and a downstream partition partitioning the passage into a first passage through which the internal air introduced from the internal air introducing port flows during the internal/external air two-layer mode and a second passage through which the external air introduced from the external air introducing port flows during the internal/external air two-layer mode, wherein
the upstream partition is disposed upstream of the first heat exchanger in the airflow direction to partition an upstream part of the passage upstream of the first heat exchanger into the first passage and the second passage,
the downstream partition is located on a downstream surface of the second heat exchanger that faces away from the first heat exchanger to partition a downstream part of the passage downstream of the second heat exchanger in the airflow direction into the first passage and the second passage, and
the downstream partition is integrally formed with the second heat exchanger.
